(19) United States
(12) Patent Application Publication
(10) Pub. No.: US 2016/0132062 A1
(43) Pub. Date: May 12, 2016

(54) SERVOMECHANISM WITH PROPORTIONAL CONTROL OF ACTION FORCE

(71) Applicant: UZDAROJI AKCINE BENDROVE "MY RESEARCH", Vilnius (LT)

(72) Inventor: Aleksej ZAICEVSKIJ, Vilnius (LT)

(21) Appl. No.: 14/890,318

(22) PCT Filed: Dec. 30, 2013
(86) PCT No.: PCT/LT2013/000018

§ 371 Date: Nov. 10, 2015

(30) Foreign Application Priority Data
May 13, 2013 (LT) 2013 044

(51) Int. Cl. G05D 17/02; G05B 11/01

(52) U.S. Cl. CPC G05D 17/02; G05B 11/01

(57) ABSTRACT

The servomechanism transmitting restrained force to a load device for use with standard remote control systems. The magnitude of the transmitted force is proportional to the control signal and does not depend on the position of the actuator. Internally or externally mounted dynamometer is used to control amount of restrained force. Elements are provided to simplify a great number of mechanical devices which require control of servomechanism output force, or an output force of a mechanism controlled by a servomechanism. It allows improving technical characteristics of many devices, by using it instead of servomechanism with load device position control. It is particularly useful in but not limited to fields, such as remotely controlled lightweight devices, robots, radio controlled models, video camera suspenders.

The present invention relates to devices with internal feedback for control of torque. At present remote and automatic control systems utilizes standardized servomechanisms with gear reducer. Arm position of a servomechanism in a radio controlled models is changing proportionally to a control signal. Modified servomechanisms without feedback with load are also available, allowing cyclical rotation at varying velocity. In some cases it is necessary to eliminate rigid connection between a load device and servomechanism reducer. For instance, if a mechanical arm with high power margin has to grip on a brittle object. In LT-5816 a device is disclosed having servomechanism being connected with load via two stretchable springs thus allowing smooth delivery of restraining force. A feedback from additional electronic modules for changing the control signal of a servomechanism is necessary for automatic control of formed restraining force. Thereby construction of a device becomes complicated and the control signal is subjected to delays.

The aim of the invention is to simplify structure of a device and improve its technical characteristics, when one needs to control servomechanism action force or action force of a mechanism controlled by servomechanism.

The object of present invention is servomechanism which forms restraining force proportional to control signal. The force sensor, dynamometer, can be integral thereby simplifying mounting of a servomechanism. The force sensor can also be externally mounted thereby increasing accuracy of measurements. A position sensor can be fitted to limit the run of a servomechanism.

The novelty of the servomechanism comprising an electric motor, a reducer and a motor controller, for use with standard remote control systems of lightweight devices, consists in using a dynamometer to measure load of a load device (7), wherein the motor controller is mounted for moving the motor shaft until restrain force of a load device is reached, wherein said restrain force matches a set difference between control signal and dynamometer signal.

The servomechanism further can be equipped with a resilient member, e.g. a spring or in other case with a magnetic sleeve, between a reducer and a load device.

A dynamometer can be connected to the servomechanism as an external and/or an additional external sensor or can be installed on a mechanism which performance is being controlled via the servomechanism.

Running of the servomechanism is limited according to signal from a load device position sensor.

In the following the invention is described in more details by reference to the attached figures, in which

FIG. 1 shows a block diagram of an exemplary servomechanism, comprising a control signal (1), an electric motor controller (2), an electric motor (3), a reducer (4), a resilient member (5), a dynamometer (6), and a mechanical load (7)

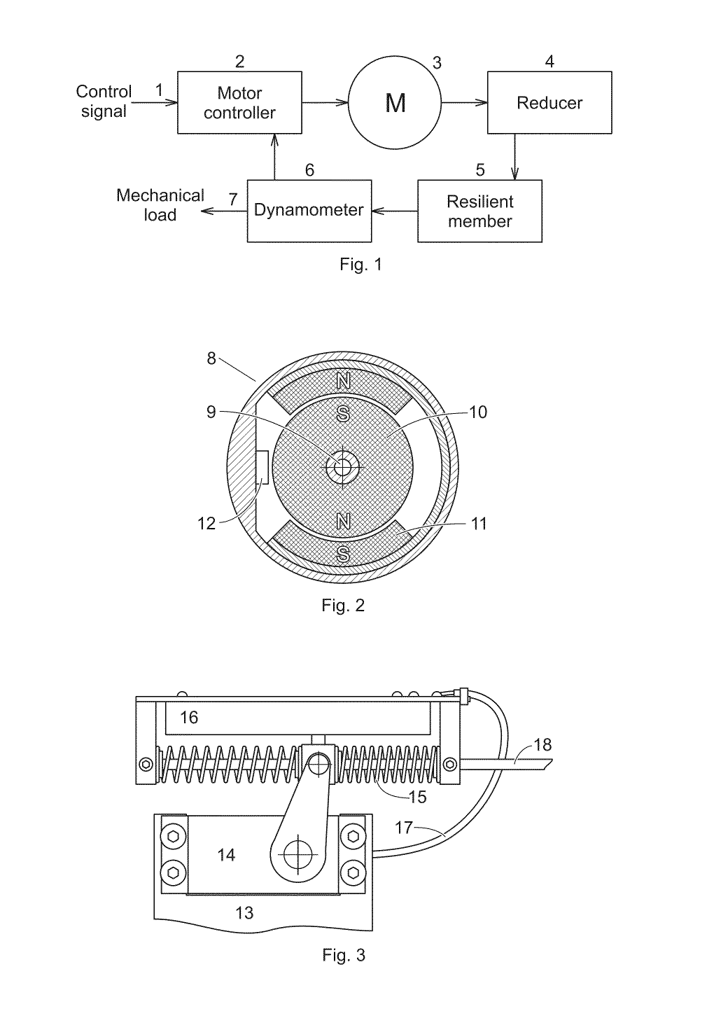

FIG. 2 shows an example of a magnetic sleeve transmission element (8) comprising at least one permanent magnet (10) of a driving part and/or at least one permanent magnet (11) of a driven part, and at least one magnetic field sensor (12).

FIG. 3 shows an example of the servomechanism with a controlled impact force, comprising a frame (13) for mounting said servomechanism, a unit (14) comprising an electrical motor, a reducer and said motor controller, springs (15), sliding potentiometer (16), electrical signal wire (17), a load device connecting rod (18).

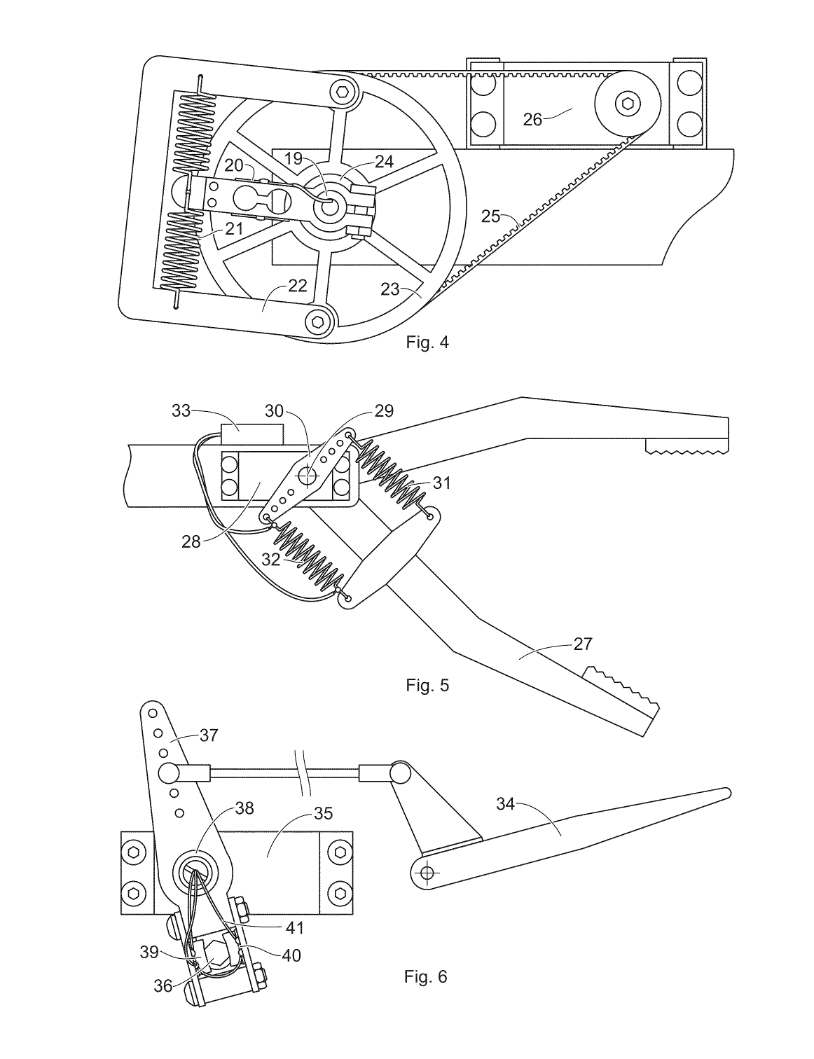

FIG. 4 shows an example of the servomechanism for control of camera tilt, said mechanism comprises video camera rotation shaft (19), strain gage force sensor (20), springs (21), frame (22) for springs, pinion (23), bearing (24), timing belt (25), and a unit (26) comprising an electrical motor, a reducer and said motor controller.

FIG. 5 shows an example of a mechanical clamp servomechanism for a manipulator, comprising a clamp (27) of a manipulator, a unit (28) comprising an electrical motor, a reducer and said motor controller, a reducer shaft (29), a rocker (30), a spring (31, 32) and the said spring sensor (32) induction measuring unit (33).

FIG. 6 shows example of the servomechanism for control of air rudder, comprising a rudder (34), a unit (35) comprising an electrical motoCa reducer and said motor controller, a pin (36), a rocker (37), a bearing (38), rubber pads (39), pressure sensitive electrical resistance member (40).

Herein the definition of servomechanism should be understood as a mechanism comprising a unit (14, 26, 28, 35) comprising an electrical motor (3), a reducer (4) and said motor digital controller (2), and a resilient member (5, 8, 15, 21, 31, 32, 39), a dynamometer (6, 12, 16, 20, 32, 40). An electrical motor (3) is associated with a mechanical load via a reducer and/or a resilient member (5, 8, 15, 21, 31, 32, 39) and a dynamometer (6, 12, 16, 20, 32, 40). Wherein the dynamometer (6, 12, 16, 20, 32, 40) provides a negative feedback for the electric motor controller (2), then the measured force magnitude is compared to control signal (1) and motor (3) shaft is turned accordingly until restrain force, which is equal to a determined error, is reached, wherein the said determined error is an allowable difference between the control signal and dynamometer signal. An electric motor controller (2) has error amplifier and a proportional-integral-derivative (PID) controller. Control signal (1) and the dynamometer (6, 12, 16, 20, 32, 40) signal can be compared more frequently than the refreshing rate of the control signal (1).

Structural difference between the invention and the, prior art is presence of a dynamometer or torque sensor.

FIG. 2 depicts the magnetic sleeve resilient member unit (8) which can be arranged as a part the servomechanism between a reducer (4) and a load device in combination with other resilient members or alone, as well as the magnetic sleeve resilient member (8) can be formed at any part of a servomechanism or a mechanism controlled by the servomechanism, provided that a magnetic field sensor (12) is mounted in such proximity to at least one permanent magnet (10, 11) that change in magnetic field around said sensor (12) can be picked up by said sensor (12) as well as provided, that said sensor (12) and said at least one permanent magnet (10, 11) are mounted in such a manner that at least one of the sensor (12) and the permanent magnet (10, 11) moves relatively one to another. In no-load state position of the at least one magnet (10, 11) is interlocked with respect to the sensor (12). Increasing a load prompts the magnetic field sensor (12) to register shift of the magnetic field of the at least one magnet (10, 11). Thereby said unit (8) functions as a: a) a resilient member; b) a torque sensor; c) isolation of the load device and the sensor from mechanical disturbances of the reducer.

FIG. 3 shows an example of servomechanism, which transfers the force acting on the load device via at least one spring (15). Deformation of the at least one spring (15) is proportional to the applied force. An external potentiometer (16) is used to measure the deformation of the at least one spring (15). Electrical signal from potentiometer (16) provides a feedback for control of said electromotor (3).

FIG. 4 shows an example of the servomechanism with an external strain gage force sensor (20). The stabilizing platforms for video cameras have to be balanced. To simplify the balancing process measured value of the impact force is displayed on the external display. The mechanism allows managing tilt of a stabilized platform with a camera regardless of the slope of an unstable foundation upon which the device is positioned. The dynamometer (20) is a strain gauge sensor of deformation. The sensor is fixed to the rotatable shaft (19) as a lever. Force on the lever is transmitted via two stretched springs (21). The springs (21) are fixed on the frame (22) which is fixed on the pinion (23). Pinion (23) is mounted on a separate bearing (24). Drive belt (25) connects the pinion (23) with a unit (26) comprising an electrical motor, a reducer and said motor controller.

FIG. 5 shows an example of a manipulator clamp servomechanism. Shaft (29) of the clamp (27) coincides with the shaft of the unit (28) comprising an electrical motor, a reducer and said motor controller. The clamp (27) and the unit (28) are connected through an extensible spring sensor (32) and an extensible spring (31), wherein the said extensible spring sensor also acts as a resilient member. The inductance of the spring sensor (32) changes when deformed. The unit (33) measures the inductance of the spring sensor (32) wherein proportionally to the applied force on the spring sensor (32) changes the resistance of the digital potentiometer (33). Digital potentiometer (33) is connected to the controller (2) in the unit (28) instead of an internal potentiometer which determines the position of the rocker (30). Thus, the external unit (33) can convert usual servomechanism with position control into the servomechanism with force feedback control.

FIG. 6 shows yet another example of the servomechanism application. The servomechanism controlled impact force can be used to control the rudder (34). The shaft of the unit (35) comprising an electrical motor, a reducer and said motor controller, coincides with the shaft of the rocker (37). The rocker (37) is fixed on the shaft of said unit (35) by a pin (36). The pin (36) is sandwiched between two rubber pads (39) and two pressure-sensitive electrical resistances (40). The force is transmitted to the rocker (37) through the pin (36), rubber pads (39) and the sensors (40). The rocker (37) is mounted on a separate bearing (38). Sensors (40) are connected to the motor controller by wires (41). Wires (41) are passed through the hollow shaft of the unit (35). In the absence of an air stream the rudder (34) position itself to a random position. In the presence of airflow the rudder (34) tends to take a neutral position. The servomechanism creates a force required for deflection of the rudder (34). At high speed air flow creates more pressure on the rudder (34) than at low speeds. That is why under the same control signal the rudder (34) will deflect less at high speeds. Such a steering mechanism of a vehicle provides a high maneuverability at low speeds and limits gravitational and mechanical overload of the device in maneuvers at high speeds. By monitoring the impact force, the steering mechanism is protected from damage in the event of jammed rudder. For more precise control of the trajectory of the vehicle servomechanism can be connected to an electronic gyroscope.

For instance, an external dynamometer of a servomechanism controls a derived/output value, which fluctuation is influenced by performance of the servomechanism. An example is a servomechanism is installed in an air motor for changing the attack angle of propeller blades. If the air pressure or the propeller rotation velocity is not constant, then changing the attack angle of the blades will result in different effect. Replacing servomechanism with position control with the mechanism with controlled restrain force would result in proportional thrust control when other conditions are within allowable limits. In this case, a dynamometer registers the air engine thrust force, but not the load of the servomechanism.

Dynamometer or force sensor as provided in examples above are sensors with different output values, in particular, but not limited to torque sensors, pressure sensors, displacement sensors, deformation sensors. Further it is possible to use dynamometers of different working principle, in particular, but not limited to magnetic, tensoresistance, pjezocrystalline, optical, capacitive, inductive.

The invention provides means to simplify a great number of mechanical devices which require control of servomechanism output force, or an output force of a mechanism controlled by a servomechanism. It allows improving technical characteristics of many devices, by using it instead of servomechanism with load device position control. It is particularly useful in but not limited to fields, such as remotely controlled lightweight devices, robots, radio controlled models, video camera gimbal.

1-15. (canceled)

16. Servomechanism with proportional control of action force comprising an electrical motor (3), a reducer (4), a force sensor (6, 12, 16, 20, 32, 40) and a motor controller (2), wherein the servomechanism further comprises a magnetic sleeve transmission element (8), which is mounted between the reducer (4) and a load device (7).

17. The servomechanism according to claim 16, wherein the magnitude of deformation is determined by using at least one driving permanent magnet (10) and a magnetic field sensor (12).

18. The servomechanism according to claim 16, wherein the load device (7) position sensor is used to limit the run.

19. The servomechanism according to claim 16, wherein the first control signal determines the position of the load device (7), and the second control signal determines maximum allowable force on the load device (7).

20. The servomechanism according to claim 16, wherein value of the impact force is displayed on an external display.

21. Method of rotating a stabilizing platform with respect to an unstable base, which comprises: providing a servomechanism according to claim 16; measuring the value of the impact force; and managing the tilt of the platform regardless of the slope of the unstable base.

22. Method of deflecting a rudder (34) of a vehicle, which comprises: providing a servomechanism according to claim 16; measuring the value of the impact force; and transmitting the force to control the rudder.
